(19) United States
(12) Patent Application Publication
(10) Pub. No.: US 2012/0269996 A1
(43) Pub. Date: Oct. 25, 2012

(54) HEAT INSULATING GLAZING ELEMENT AND METHODS FOR ITS MANUFACTURE

(76) Inventor: Steffen Jäger, Braunschweig (DE)

(21) Appl. No.: 13/512,610

(22) PCT Filed: Dec. 4, 2010
(86) PCT No.: PCT/DE2010/001442

§ 371 Date: May 30, 2012

(30) Foreign Application Priority Data
Dec. 18, 2009 (DE) 10 2009 058 789.6

(51) Int. Cl. E06B 3/663; E06B 3/24

(52) U.S. Cl. 428/34; 156/109

(57) ABSTRACT

A heat insulating glazing element comprises a glass pane arrangement with a first outer glass pane and a second outer glass pane, of which the first outer glass pane protrudes the second outer glass pane along the entire circumference by an overlapping surface, a spacer assembly comprising spacers provided for setting a distance between the glass panes, and an edge seal assembly for scaling a gap between the glass panes against the surroundings and comprises a profiled frame attached vacuum-tight to the overlapping surface of the inside of the first outer glass pane, wherein the glazing element is set up in such a way that the pressure in the gap is lower compared to the exterior atmospheric pressure, and wherein the frame is attached vacuum-tight to an outer face of the second outer glass pane and forms an evacuated space connected to the gap at the side edge of the second outer glass pane, and at least one evacuating device is provided which is arranged through the frame for the evacuation of the evacuated space.

### RELATED APPLICATIONS

This is a §371 of International Application No. PCT/DE2010/001442, with an international filing date of Dec. 4, 2010 (WO 2011/072646, published Jun. 23, 2011), which claims the priority of German Patent Application No. 10 2009 058 789.6, filed Dec. 18, 2009, the entire contents of which are hereby incorporated by reference.

### TECHNICAL FIELD

The disclosure relates to a heat insulating glazing element and methods for its manufacture. Furthermore, uses of the glazing element are also described.

### BACKGROUND

It is generally known from prior art how to manufacture vacuum insulated glass with at least two glass panes, which comprise an evacuated gap and are connected to one another by means of defined spacers and a circumferential scaling assembly. The spacers are distributed between the glass panes across their entire surface at a distance between one another of 20 mm to almost 50 mm or more, e.g. using a uniform dot screen. The vacuum in the gap can be generated by means of evacuating devices arranged in one of the glass panes and/or at the edge seal—assembly and/or in a vacuum chamber. For example, WO 87/03327 A1 describes a glazing element with a glass pane arrangement whose edge seal assembly comprises a profiled frame attached vacuum-tight to inner faces of outer glass panes of the glass pane arrangement.

The vacuum is provided to prevent heat losses as a result of convection and thermal conduction of the gas between the glass panes. It is the crucial parameter for achieving high thermal insulation values with the vacuum insulated glass. Therefore, the requirements for the quality of the vacuum (achievable pressure), the maintenance and improvement of the vacuum (vacuum tightness and gettering) as well as the method for the provision of the evacuating device and the edge seal assembly are high. The edge seal assembly is particularly important because not only the vacuum tightness needs to be secured with it, but the mechanical and thermomechanical strains associated with the use of the component as well as the forced deformations, e.g. due to thermal expansions without loss of function need to be at least partially absorbed and compensated. Conventional techniques have so far not or only inadequately taken into account such warpages impacting all directions in space.

Strains develop in particular as a result of the combination of the exterior air pressure and the differing thermal expansion of the individual glass panes against each other. The latter is due to the fact that the individual glass panes have different temperatures depending on their intended use. For glazing of buildings for example, the inner glass pane usually has an almost constant temperature, while the outer glass pane on the other hand may have a significantly higher or significantly lower temperature. The temperature differences of the glass panes of e.g. up to 60 K and more cause different thermal expansions and as a result different changes of the geometric dimensions of the glass panes against each other, which need to be compensated with the edge seal without compromising the vacuum tightness. In the process, even minor displacements of the glass panes against each other can cause such a high mechanical or thermomechanical tension that the glass pane edges and/or the edge seal assembly can be damaged, thus resulting in an uncontrollable and complete destruction of the glazing element. Even with average component geometries of approximately 1.5 m, the changes of the geometric dimensions triggered by the temperature fluctuations are after all in the 1 mm range and higher. However, even larger component dimensions are required in the practice.

The susceptibility of vacuum glazing is particularly high in the corner areas where thermal expansion phenomena occurring in all directions have a local overlap and the associated mechanical tension may even cause warpages or similar effects.

In the practice, damages or destructions of conventional vacuum glazing elements can be determined in the form of fractures and chips involving the entire edge region due to the improper application of ductile and glass-like adhesive and bonding materials. In addition, warpages along the glass edges are observed in conventional vacuum insulated glazing, caused for example by local shadowing, local cooling or similar effects. It must also be possible that a functional edge seal is capable of absorbing and compensating such locally changeable or locally active load or force components without being damaged.

The provision of the heat insulating glazing elements is associated with high requirements for the process technology in terms of precision, reliability and reproducibility. As a result, interest in methods for the manufacture of the heat insulating glazing elements exists, which meet the outlined requirements, have a minimal scrap rate and are at the same time cost-effective. Conventional procedures are unable to meet these requirements adequately some disadvantages as well as process and technology-related problems of conventional vacuum insulated glasses are described in more detail below.

A first disadvantage of the known vacuum insulated glazing is that only very small volumes for the evacuation are available, which are arranged between the glass panes. For the typical distances of the glass panes of e.g. approximately 50 μm to 300 μm, the values for the volumes are only about 0.05 L to 0.3 L per square metre. In contrast, the inner surface of the glass surfaces facing the evacuated gaps is very large, meaning that the known vacuum insulated glazing is equipped with extremely low volume-to-surface ratios of less than 0.5 mm (typically between approximately 0.025 mm and 0.15 mm). These particularly unfavourable conditions result in the fact that residual gas molecules (e.g. water, hydrocarbons etc.) or other contaminations caused e.g. by desorption or diffusion processes or similar which are absorbed or bound even in very low concentrations on the inner surfaces, the areas close to the surfaces or the spacers are released and cause an unwanted pressure increase in the evacuated gaps. For example, a rise in temperature or irradiation as they constantly occur in connection with the common conditions for use of the glazing elements are sufficient for the release of such residual gas molecules (“virtual” leaks). Because only very small volumes are available, the effects of residual gas molecules, even in the tiniest of quantities, may be extremely unfavourable, because the rise in pressure results in a pronounced deterioration of the heat insulating properties of the vacuum insulated glazing to the point of total failure of the components in some cases already after a short period of time.

Another disadvantage of conventional vacuum insulated glazing is the fact that extremely long evacuation times ranging from several minutes to in some cases several hours are required for the provision of the required vacuum below 10⁻¹ Pa to 10⁻³ Pa or lower. Therefore, the manufacture of the components is very expensive and in some cases, additional high technical and financial expenses are required for the evacuating device. The evacuation concerns the transition of the viscous gas flow at high pressure into molecular flow at low pressure. The molecular flow starts as soon as the average free pathway of the molecule-to-molecule collisions is about equal to the distance between the glass panes. With a typical distance between the glass panes of about 50 μm to 300 μm, this situation occurs with pressures as low as several ten Pa (air at room temperature). However, this is by far insufficient to achieve the particularly good thermal insulation values of lower than 0.8 W/(m²K), in particular lower than 0.5 W/(m²K). With respect to the molecular flow, the suction speed depends to a high degree on the geometric conditions of the volumes to be evacuated. For example, in this flow range, the suction speed through an evacuated tube depends on the fourth power of the diameter. As a result, a small enlargement of the cross-section alone results in a significant reduction of the evacuation times or vice versa; diameters that are too small result in remarkably long evacuation times.

The conditions for reducing the evacuation times are particularly unfavourable with conventional vacuum insulated glazing. On the one hand, the evacuation time depends on the dimensions of the cross-sections of the spaces between the glass panes to be evacuated. Because the distances between the glass panes are low (low conduction value), the gas molecules require a very long time to accidentally get to and ultimately through the evacuating device, largely as a result of the collisions with the glass surfaces to be subsequently evacuated by means of the vacuum pump. Another aspect is that the actual evacuation usually occurs locally, with an evacuated tube either attached to the edge of the glazing assembly or to one of the glass pane surfaces. However, for construction-related reasons, the evacuated tubes of conventional vacuum insulated glazing can only be provided with small diameters, typically ranging between about 1 mm and 2 mm. These diameters are much too small to carry out a rapid and therefore cost-efficient evacuation. Indeed it is in principle possible to arrange several evacuated tubes simultaneously to increase the effective cross-section. However, this requires the provision of extensive additional technical facilities which drive up the costs even higher. In addition, it needs to be considered that the gas molecules which are further away from the evacuating device need to travel the entire path through the extremely narrow opening between the glass panes to be finally pumped off via a narrow evacuated tube. This results to an additional increase of the pumping times, especially in large-size glazing elements.

These disadvantages cannot be compensated even with the evacuation of the vacuum insulated glazing in a technically advanced and expensive vacuum system. Indeed, this method allows the shortening of the evacuation time in that the molecules are now moving into the vacuum chamber on all the sides of the glazing elements and can be evacuated. However, we need to keep in mind that before the evacuation the glazing elements first need to be transferred into the vacuum assembly and that the vacuum chamber subsequently needs to be evacuated to achieve good pressures of at least 10⁻¹ Pa to 10⁻³ Pa; this means that the evacuation times in this case are comparable or even longer. In addition, it needs to be considered that the vacuum-tight sealing of the glazing elements needs to be conducted inside the vacuum system as well, which has proven to be very complex and very expensive in the practice.

Another disadvantage of common vacuum insulated glazing is that the very small volumes between the glass panes do not provide sufficient space to accommodate a sufficient quantity of getter materials. Finally, no adequately evacuated space is available within the known glazing elements in which the getter materials can be activated for example through thermal evaporation, without the evaporated materials being visible in a disturbing way for the user, which is ultimately identical to an impaired quality of the glazing elements.

The corner areas of the conventional glazing elements represent another critical point, where the longitudinal and form changes acting in different directions in space overlap in a complex manner and the values of the mechanical tensions occurring there are particularly high. In the practice, fractures, chips, material fatigue to the point of glass breakage are observed in conventional glazing elements. It needs to be taken into account that the mere formation of micropores and microfractures or other sometimes microscopically small damages in the corner areas suffices to render the glazing elements completely useless, because the vacuum inside the glazing elements cannot be conserved because of the leak in these areas. Especially if foils are used to provide the edge seal, it has been shown that folding the foils around the corners creates folds, kinks and similar effects. As a result, no complete vacuum tightness can be guaranteed. These problems are all the more serious the larger the dimensions of the glazing elements are. The known methods do not provide adequate teachings allowing the user to provide glazing elements which are capable of overcoming the existing disadvantages and can be manufactured with large dimensions.

An aspect of the disclosure is to provide an improved glazing element which is suitable to prevent the disadvantages of conventional glazing elements. In particular, the glazing element is supposed to be characterised by high mechanical stability, a simple design and simplified manufacture. The disclosure includes providing a glazing element with an edge length of up to 2,500 mm and freely selectable geometries above the edge (shape, size) in such a way that a high vacuum can be maintained within the glazing element throughout the entire product life. In addition, the disclosure includes providing an improved method for the manufacture of a glazing element which is suitable to prevent the disadvantages of conventional techniques for the manufacture of glazing elements.

These aspects and others may be solved with a glazing element and method for its manufacture in accordance with this disclosure and with the features of the independent claims.

### SUMMARY

According to an exemplary aspect of the disclosure, a glazing element comprises a glass pane assembly with at least two glass panes of which a first outer glass pane protrudes a second outer glass pane along the entire circumference by an overlapping surface. In addition, the glazing element comprises a spacer assembly comprising spacers provided for setting a distance between the glass panes. The spacers form a gap between the glass panes in which the pressure is reduced compared to the exterior atmospheric pressure. In addition, the glazing element comprises an edge seal assembly set up to seal the gap between the glass panes against the surroundings. According to the disclosure, the edge seal assembly comprises a profiled frame which is attached vacuum-tight to the protruding surface of the inner face of the first exterior glass pane and to one outer face of the second outer glass pane and forms an evacuated space connected with the gap at the side edge of the second outer glass pane.

### DETAILED DESCRIPTION

As an example, the edge seal assembly is formed with a profiled frame made of a leaf or foil-shaped, several fold curved, dimensionally stable material. The frame comprises fixing areas (links), on which the frame is connected extensively with the glass panes, and profiled areas extending between the fixing areas. The fixing areas comprise two essentially level areas parallel to each other, which are rigid because of their connection with the glass panes. In the event that the glass panes become deformed (for example as a result of thermal expansion), no or only minor deformations of the fixing areas can occur, meaning that no critical peeling forces perpendicular to the surfaces of the glass panes will occur.

The profiled areas which form the transition from a first of the fixing areas on the first glass pane to the second fixing area are mechanically ductile. The profiled areas can be level or curved in some places. Parts of the profiled areas which are curved more than their surroundings are referred to as arched areas. The radius of bend of the arched areas is at least 0.5 mm, preferably at least 1 mm. The frame forms a several fold wavy or arched leaf extending alongside the edges of the glass panes. The frame is shaped like a bellows whose folds are not kinked but rather curved and formed by the arched areas.

The profiling of the frame is shaped by the selection of the material and its thickness in such a way that the shape of the profiled areas including the arched areas is not or only insignificantly changed by the exposure to the exterior air pressure. This represents a significant advantage compared to the foil provided for the conventional glazing element, in which strong deviations would occur because of the air pressure forces and the material would therefore not be able to withstand the forces caused by the deformation of the glass panes.

Because of the connection between the inner face of the larger glass pane and the outer face of the smaller glass pane, the dimensionally stable frame of the glazing element according to the invention is advantageously suitable both to create a solid connection between the glass panes and to tolerate possible deformations resulting from movements or size changes of the glass panes without interrupting the vacuum-tight connection with the glass panes.

Because of the connection between the frame and the outer face of the smaller glass pane, the evacuated space connected with the gap is advantageously enlarged compared to a conventional glazing element, e.g. according to EP 247 098, so that advantages for the evacuation of the glazing element and the absorption of thermal movements of the glass panes relative to one another are achieved.

The evacuated space is also enlarged compared to a conventional glazing element as a result of the several fold arched shape of the frame's profile, wherein an additional evacuable buffer and/or function space is advantageously created.

According to another aspect of the disclosure, a component comprises at least one glazing element according to the aspect above. The component is e.g. a window for a building or a vehicle characterised by long-term stability of the thermal insulation. The component has an outer face provided to point toward an exterior surrounding when the component is installed and an inner face provided to point toward the inside, e.g. of the building or the vehicle when the component is installed. The largest outer glass pane of the glass pane assembly can be provided on the inner face or the outer face of the component.

According to another aspect of disclosure, a method for the manufacture of a glazing element is provided according to the aspect above.

According to an exemplary embodiment of the disclosure, the frame of the glazing element comprises several arched areas extending alongside the side edges (margins) of the glass panes. The arched areas can be curved parallel to the protruding surface in one direction, i.e. the profile of the edge seal assembly is wavy perpendicular to the extension of the glass panes. In this case, a plurality of arched areas above the protruding surface may produce advantages for the enlargement of the evacuated space. Alternatively, the arched areas can be curved perpendicular to the protruding surface in one direction, i.e. the profile of the edge seal assembly is wavy parallel to the extension of the glass panes. In this case, enlarged profiled areas above the protruding surface may produce advantages for the enlargement of the evacuated space. According to other preferred embodiments of the invention, the profiled areas of the frame are arranged almost perpendicular or almost parallel to the protruding surface.

According to another exemplary embodiment of the disclosure, the arched areas—if curved parallel to the protruding area—are shaped in such a way that the arched areas pointing to the first outer glass pane are at least partially in mechanical contact with the inner face of the latter. The arched areas rest on the protruding surface on the inner face of the first glass pane, wherein mechanical support points are advantageously formed which stabilise the frame. The inventor determined that this stabilising function can surprisingly be achieved without sealing off the evacuated space.

The fixing areas are connected with the glass panes alongside sealing surfaces. According to another preferred embodiment of the invention, the first sealing surface and the second sealing surface are designed level and parallel to each other. The attachment of the first fixing area of the frame via the first sealing surface on the always (in each case) larger glass pane toward the inside and the attachment of the second fixing area of the frame above the second sealing surface on the always (in each case) smaller glass pane toward the inside has the advantage that one side (surface) of the frame material is connected to both the first as well as the second outer glass pane. The connection is achieved without switching the surface, thus improving the stability of the frame.

Special advantages for the mechanical stability of the frame-to-glass pane connection and the vacuum tightness are achieved if according to another preferred variant of the invention, the first sealing surface and the second sealing surface comprise a solder glass or contain it at least partially which softens at a temperature of below 600° C., in particular below 540° C. Especially preferred the fixing areas comprise a thermal expansion coefficient matched to the thermal expansion coefficient of the glass panes and the frame, i.e. selected with a minimal difference to these. It has been shown to be particularly advantageous if the sealing surfaces contain at least one of the oxides of the elements lead, lithium, bismuth, sodium, boron, phosphorus and silicon.

The frame of the edge seal assembly may be shaped and connected to the glass panes in such a way that the exterior atmospheric pressure acts on the first and second fixing areas of the frame if the glazing element is in evacuated status. This pushes the fixing areas against the sealing surfaces, stabilising them additionally.

Another exemplary embodiment of the invention is characterised in that a perpendicular distance between an inside edge of the first sealing surface pointing to the evacuated space and a next spacer is smaller or equal to 70 mm, in particular smaller or equal to 45 mm.

The frame of the glazing element according to the disclosure may be provided with one or combinations of the following features. If the frame comprises at least a C-, U-, Z-, Ω- or S-profile, the dimensional stability of the profiled areas including the arched areas is particularly high. The frame may comprise at least three arched areas. It is possible to combine several of the mentioned profiles to form the at least three arched areas with alternating opposite orientation (curve). The dimensional stability can additionally be improved if the frame comprises stabilising elements, such as for example recesses, channels or grooves. As well, variations of the thickness and/or stability (rigidity), such as alongside the direction of the edges of the glass panes and/or perpendicular to them, achieve a mechanical stabilisation of the frame. The thickness of the material of the frame may be lower than 500 μm. The inventor determined that greater thicknesses can create extremely high tensions in the frame material (e.g. at the arches) and that the thermal deformations of the glass panes can result in premature material fatigue. In addition, frame material that is too thick and as a result rigid can cause extremely high forces in the region of the sealing surfaces, thus resulting in impaired vacuum tightness. The thickness of lower than 300 μm is particularly preferred. In addition the thickness of the material of the frame is preferably greater than 50 μm. Lower thicknesses have proven to be excessively sensitive against mechanical loads. The thickness of greater than 70 μm is particularly preferred.

The frame may comprise at least one of iron-nickel (FeNi), iron-nickel-chromium (FeNiCr), iron-chromium (FeCr), platinum, vanadium, titanium, chromium, aluminium and cobalt, in particular a Fe—Ni alloy with a nickel share of 40% to close to 55%, a Fe—Ni—Cr alloy, a Fe—Cr alloy with a chromium share of 23% to 30% or a high-grade steel with a chromium share of 15% to 20%.

According to another exemplary embodiment of the disclosure, the frame is assembled with edge parts and corner connectors to form an enclosed continuous component. The edge pans extend alongside the edges of the glass panes and are connected with the respective adjacent corner connectors in the corner areas of the glass panes. The corner connectors each comprise a rounded, in particular several fold curved material web. The frame is formed in the corner areas of the glass panes by the corner connectors, which are connected vacuum-tight with the edge parts extending alongside the longitudinal edges. The area where the edge parts and corner connectors are connected is also referred to as connecting or transition area. A closely contoured connection may be provided.

The glazing element according to the disclosure may be equipped with at least one evacuating device which is configured for the connection between the glazing element and a vacuum assembly, for the evacuation of the evacuated space and via the latter the gap between the at least two glass panes and for a vacuum-tight sealing after the evacuation. According to the disclosure, the evacuating device forms an evacuating line which runs through the frame of the edge seal assembly. The purpose of the evacuating device is to facility the evacuation through the frame. In contrast to the conventional evacuation through one of the glass panes, e.g. according to EP 247 098, a faster evacuation is advantageously achieved during the manufacture of the glazing element and drilling through the glass panes can be avoided. The inventor determined that the evacuating device forms an adequately stable and permanently vacuum-tight connection with the profiled edge seal assembly according to the invention.

The evacuating device may comprise at least one evacuated line set up for attaching the vacuum assembly and a cuff area at least partially fitted to the profile of the frame which is connected vacuum-tight with the frame. The evacuated line features e.g. a circular inside cross-section (evacuated pipe) or a different shape of the cross-section, depending on the intended use. According to the disclosure, the cuff area can be connected vacuum-tight with at least one of the edge and corner connectors.

Alternatively or additionally, the evacuating device can be a corner piece which replaces one of the corner connectors of the frame. The corner piece is e.g. a preformed (in particular punched, remodelled) metallic component with an opening for an evacuated line which can be welded into the corner piece.

The disclosure is not limited to a glazing element with exactly two glass panes, but can also be realised with a glass pane arrangement with three or more glass panes. At least one inner glass pane can be arranged between the first and the second glass pane, whose surface area is smaller than the surface area of the first outer glass pane, wherein the gap between the glass panes leads into the evacuated space. The at least one inner glass pane does not touch the edge seal assembly on one example.

The creation of the enlarged evacuated space achieved with the edge seal assembly according to the disclosure compared to the conventional state of the art has an additional advantage in terms of the attachment of ancillary equipment in the evacuated space. For example, at least one sensor assembly, e.g. to register the residual gas or its properties (e.g. thermal conductivity, ionisation behaviour, absorption and emission behaviour etc.), at least one measuring assembly, e.g. to measure the pressure and at least one getter assembly can be provided in the evacuated space.

For the exemplary manufacture of the glazing element according to the disclosure, the provision of the glass panes as glass stack with the spacers of the spacer assembly, the material of the frame of the edge seal assembly with the edge and corner connectors and the at least one evacuating device is carried out first. Then the material of the frame is cut to the desired dimensions and shapes of the edge and corner connectors. At least one opening is provided in the material of the edge and/or corner connectors of the edge seal assembly, and the at least one evacuating device is attached in the opening. Then the glass pane stack, the frame of the edge seal assembly and the evacuating device are pooled and the vacuum-tight connections of the edge parts, the corner connectors and the evacuating device are provided to form the circumferential frame and the vacuum-tight connections of the frame with the outer faces of the outer glass panes of the glass pane stack. Finally, the evacuation of the glazing element, the sealing of the evacuating device and the fastening of an enclosure are provided such as they are known from conventional glazing elements.

### BRIEF DESCRIPTION OF THE DRAWINGS

FIG. 1 is a schematic cross sections of an exemplary embodiment of the glazing element according to the disclosure;

FIGS. 2 to 4 are schematic cross sections of variants of a frame designed according to the disclosure;

FIGS. 5A to 5E are schematic cross section of additional variants of a frame designed according to the disclosure;

FIGS. 6A and 6B are schematic top views to illustrate the corner connection areas of the frame designed according to the disclosure; and

FIGS. 7 and 8 are illustration of features of an exemplary method for the manufacture of a glazing element according to the disclosure.

Exemplary embodiments of glazing elements and methods for their manufacture according to the disclosure are described in particular with reference to features of the edge seal and evacuating devices. In addition, the glazing elements can be realised as described in DE 10 2006 061 360, DE 10 2007 053 824 and DE 10 2007 030 031, whose content with respect to the features, in particular the components, the design, the solar absorption properties, the facilities for the creation and sealing of the vacuum and the provision of spacers and spacer-containing glass panes of the glazing elements is integrated into the description in hand and incorporated herein by way of reference. The realisation of the disclosure is not limited to these glazing elements, but is realisable analogously with glazing elements whose design is different in particular with respect to the arrangement, shape, size and materials of the glass panes and the spacers.

We would like to emphasise that the enclosed drawings show schematic representations of sections of the glazing elements. When the disclosure is realised, geometric or mechanical features of the glazing elements may be designed differently than shown, depending on the specific conditions. The glazing element according to the disclosure e.g. not only allows level constructions in freely selectable shapes and formats, but in particular also curved or bent constructions. The disclosure may be realised with a glazing element with at least three glass panes, but it can also be used with vacuum insulated glasses whose glass pane arrangement consists of two glass panes or more than three glass panes.

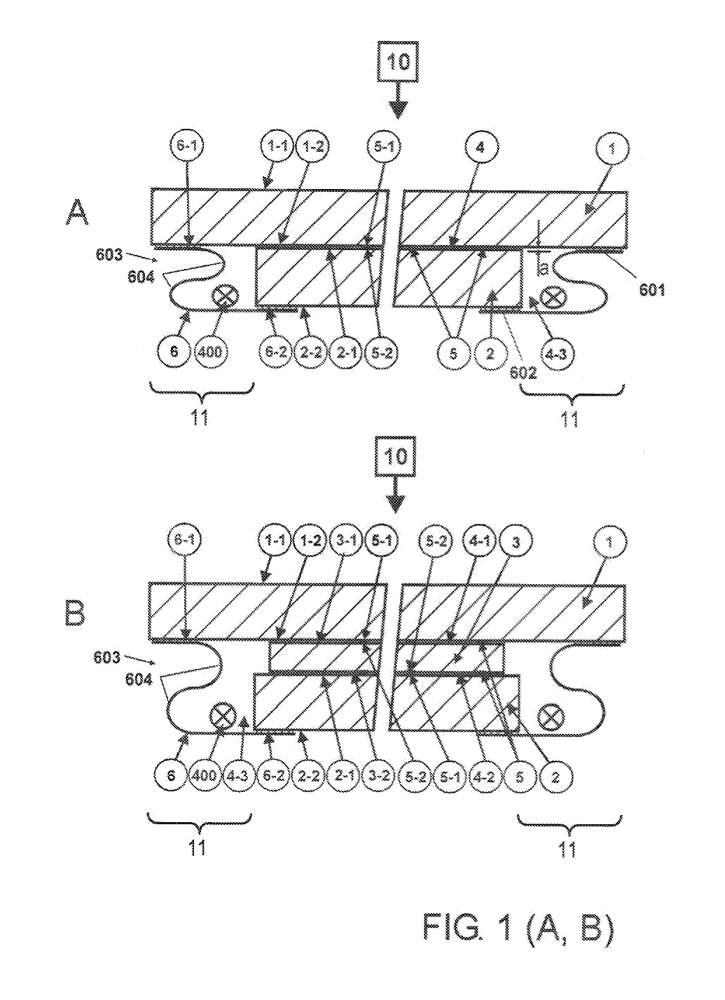

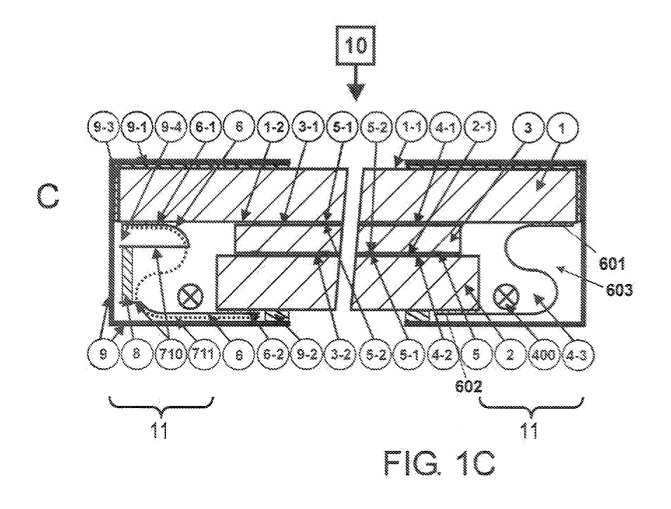

The FIGS. 1A to 1C show variants of the glazing element 10 with a glass pane arrangement designed with two or three glass panes 1, 2, 3. Specifically, the glazing element 10 according to FIG. 1A comprises a glass pane arrangement with a first outer glass pane 1 and a second outer glass pane 2. According to FIGS. 1B and 1C, a third inner glass pane 3 is provided which is arranged between the glass panes 1, 2. The glass panes each comprise surfaces 1-2, 3-1, 3-2 and 2-1 analogously arranged on the inside as well as surfaces 1-1 and 2-2 arranged on the outside. Evacuable spaces 4, 4-1, 4-2 and 4-3 are formed between the glass panes 1, 2, and 3. To prevent the loss of heat as a result of thermal radiation, at least one of the inner surfaces 1-2, 3-1, 3-2, 2-1 is equipped with thermal protection coating (see e. g. DE 10 2006 061 360.0).

The surface of the first outer glass pane 1 is larger than the one of the second outer glass pane 2 and is arranged in such a way that the second outer glass pane is protruded along the entire circumference by the outer glass pane 1 by an overlapping surface 11. The overlapping surface 11 forms a strip around the entire circumference of the inner face of the first outer glass pane 1. In addition, the glazing element 10 comprises a spacer assembly 5, provided for setting the distances a (see FIG. 1A) between the glass panes 1, 2, 3 and comprises spacers 5. The illustrations provide e.g. that the third glass pane 3 arranged between the outer glass panes 1, 2 is provided on both sides with fixed spacers on the glass surfaces 3-1 and 3-2 above the first contact areas 5-2, while the adjacent glass panes 1 and 2 in the region of the second contact areas 5-1 of the spacers 5 are allowed to move almost freely. FIGS. 1A to 1C provide illustrations of exemplary spacers 5 with spherical or similarly shaped contact areas 5-1 because of the flattening of the geometry of the spherical segment.

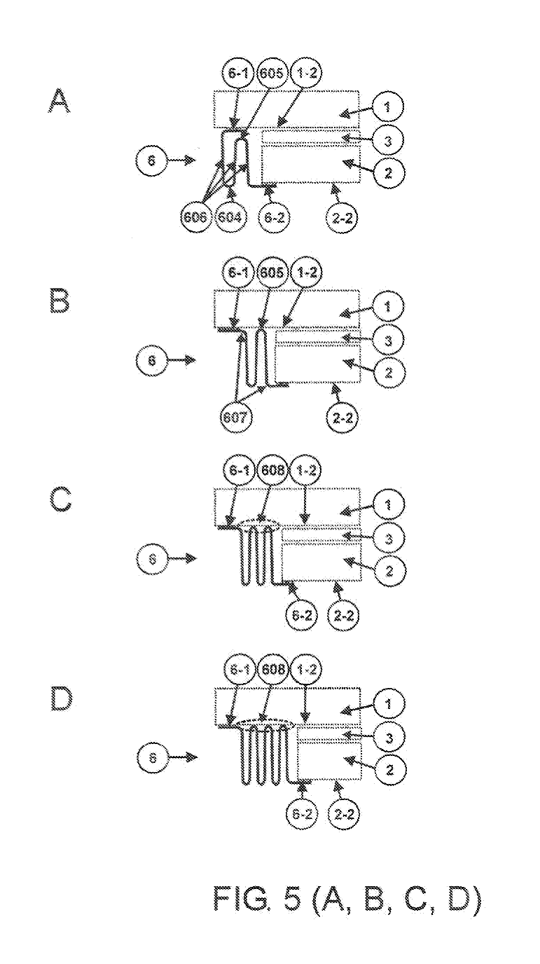

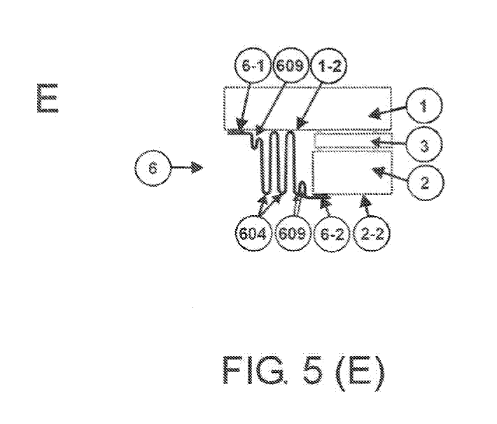

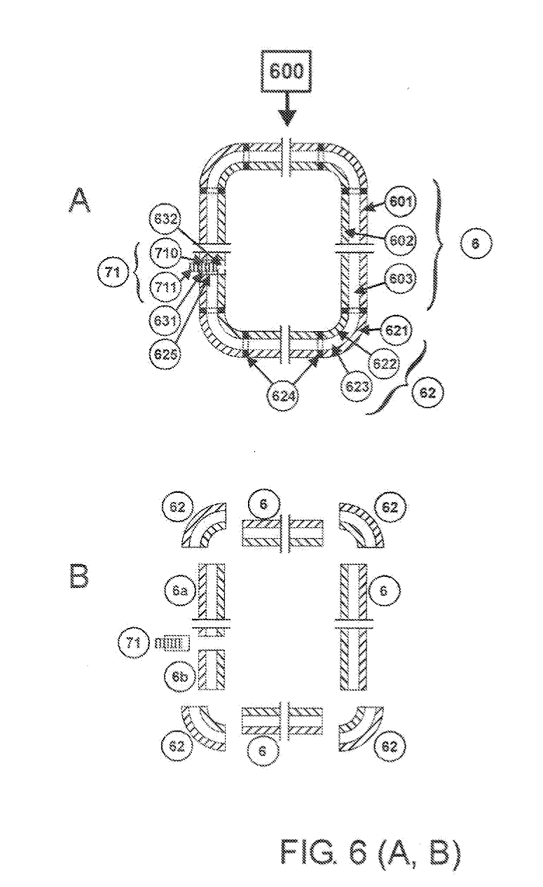

Furthermore, the glazing element 10 comprises a vacuum-tight edge seal assembly 601-604 arranged around the entire circumference of the edge of the glass panes 1, 2, 3, which is provided to seal the gaps 4, 4-1 and 4-2 between the glass panes as well as an evacuated space 4-3 against the surroundings of the glazing element and which can be enclosed with an enclosure 9, 9-1, 9-2, 9-3, 9-4 (FIG. 1C). The edge seal assembly 601-604 forms a profiled frame 6 and is also shown with reference number 600 in FIG. 6. The frame 6 comprises fixing areas 601, 602, on which the frame 6 is connected to the glass panes via sealing surfaces 6-1, 6-2, and a profiled area 603 with a plurality of arched areas 604 between the fixing areas 601, 602 (621, 622 and 631, 632). The arched areas 604 extend alongside the side edges of the glass panes (in FIG. 1 perpendicular to the plane of projection) and are curved to one direction parallel with the protruding surface 11. Between the arched areas 604 the profiled area 603 of the frame 6 is arranged almost perpendicular to the protruding surface 11. Alternatively, the arched areas 604 can be curved in one direction perpendicular to the protruding surface 11 (see e.g. FIG. 5). In this case, the profiled area 603 between the arched areas 604 is arranged almost parallel to the protruding surface 11.

The frame 6 comprises edge parts, which are shown e.g. in the FIGS. 1 to 5 as cross-sections and corner connectors which are described below with reference to FIG. 6.

To improve or conserve the vacuum, getter materials and/or assemblies comprising getter effects 400 are provided. An evacuating device 710, 711 provided on the side leads through the profiled frame 6 or parts thereof, in which e.g. a scaling element 8 is arranged (FIG. 1C). Alternatively, the evacuation can be provided through at least one opening which is arranged on at least one of the glass pane surfaces arranged toward the outside.

As the inventor determined by means of experiments, disadvantages of the conventional glazing elements can surprisingly be remedied with the provision of additional evacuated evacuated spaces 4-3 arranged around the entire circumference of the glass panes, which are determined by the type of attachment and the geometry of the profiled frame 6 and the evacuating devices 71.

The disclosure makes it possible to significantly improve the important volume-to-surface ratio in the evacuated interior of the glazing element 10. Depending on the design variant (size and number of glass panes, attachment and geometry of the profiled frame, etc.), the volume-to-surface ratios can be increased to about 100% and even higher. The significance of this increase becomes particularly significant because of the fact that the product life of the glazing elements 10 according to the disclosure compared to the conventional vacuum insulated glazing (see otherwise identical conditions such as e.g. leak rate etc.) can be doubled with an increase by 100%. Consequently, the glazing elements according to the invention can now be used for as many as 40 rather than 20 years as was the case in the past. Additional significant advantages are achieved with the production, e.g. with the reduction of the pumping times.

It has been shown to be particularly advantageous that the high shearing and torsional forces that are sometimes generated as a result of the expansion/deformation of the glass panes 1, 2, 3 can be compensated particularly well with the edge seal assembly and the evacuating device 6, 600, 71 and can be rendered innocuous, making it possible to provide the glazing elements 10 in freely selectable sizes and shapes. These advantages identified in comparison to the prior art are preferably due to the complex interaction of the special features of the invention, comprising the arrangement of differently sized glass panes 1, 2 and the specific attachment of the frame 6 exclusively only on the glass pane surfaces 1-2, 2-2, and the arrangement of at least one section of the profiled frame 6 along the edges of the glass panes 1, 2.

The set-up of the additional evacuated spaces 4-3 according to the invention makes it possible to integrate sensors, sensing elements or similar equipment for the characterisation or control of the vacuum and as a result indirectly also for the measurement of the thermal insulating properties of the vacuum-tight sealed component. This can be e.g. pressure measurement assemblies with an electrical, optical, oscillation-mediated effect or combinations thereof, and/or assemblies containing materials whose physical properties change depending on the pressure (e. g. reflexion, absorption, colour properties resulting e.g. from adsorbates, chemical reactions or similar, pressure-related evaporation and/or sublimation properties, combinations thereof). To read out the direct or indirect measured parameters and information for the pressure, e.g. electrical leadthroughs in the profiled frame 6 and/or a contactless optical observation through glass pane 1 and/or facilities with an electro-magnetic effect may be provided.

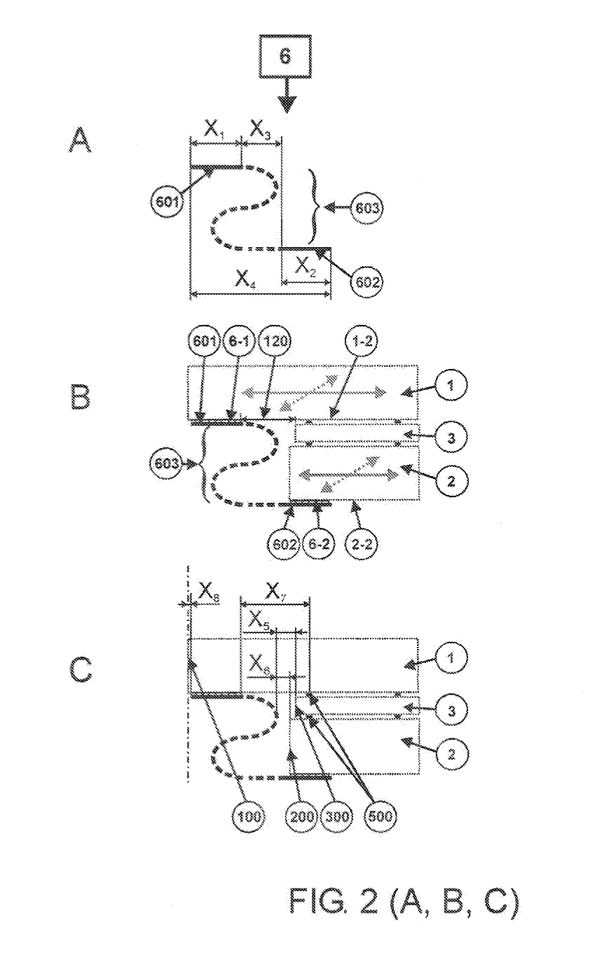

FIGS. 2A and 2B show the profiled frame 6 which at least partially consists of a metal or a metal alloy. Advantageously, the profiled frame 6 comprises at least two fixing areas 601 and 602 which are almost plane and arranged almost parallel to each other, between which a mechanically malleable profiled area 603 (here exemplified with an S-shaped geometry) comprising a plurality of turns, arches, curvatures, bevels is provided.

The provision of the vacuum tightness of the glazing element 10 and the asymmetrical attachment of the profiled frame 6 on the glazing element 10 is provided via sealing surfaces 6-1, 6-2, which are attached according to the invention at least partially between the fixing areas 601, 602 of the profiled frame 6 and the glass panes 1, 2 (see FIGS. 1 and 2B), each facing a common outer face. Preferably, the glass panes 1, 2 have different sizes and are arranged offset against each other. The glass pane 1 is always larger than the other glass panes 2, 3.

According to the disclosure, the profiled frame 6 is attached in such a way that the sealing surface 6-1 is prepared first on the respective larger of the two glass panes 1, 2 in the edge area of surface 1-2 of glass pane 1 pointing inward to the gaps 4, 4-1, and the sealing surface 6-2 is prepared on glass pane 2 which is smaller compared to glass pane 1, at the edge of surface 2-2 pointing outward and, thirdly an additional evacuated space 4-3 with an average cross-sectional area Aᵥ is set up. The extensions x₁, x₂ of the fixing areas 601, 602 of the profiled frame 6 which are arranged at least almost parallel to each other are set to values ranging between about 3 mm and about 15 mm.

It is particularly advantageous that the asymmetrical attachment of the edge seal assembly 601-604 according to the disclosure on glass panes 1 and 2 always facing the same exterior face is not limited to glass pane arrangements consisting of only two or three glass panes, but can be used without any problems with any number of glass panes with any thicknesses. The glass pane 3 arranged on the inside is not in contact with the edge seal assembly 601-604, meaning that the latter is still freely moveable, i.e. displaceable between the glass panes 1, 2 even after the glazing element 10 has been completed. The arrangement of edge 300 of the glass pane 3 (see FIG. 2C) compared to edge 200 of glass pane 2 is preferably offset slightly toward the inside, toward the centre of the component or close to flush to help prevent damages during the installation or the use of the glazing element 10. With respect to the distance x₅ (see FIG. 2C) between the profiled frame 6 and the edge 300 of glass pane 3 arranged on the inside, it is preferable if it is at least about 1 mm to help reduce the evacuation times. As well, the distance x₆ (see FIG. 2C) between the profiled frame 6 and the edge 200 of glass pane 2 is set to at least about 1 mm or larger. The average cross-sectional area Aᵥ corresponds to the area which is mounted through the frame geometry pointing toward the inside of the glazing element, the glass edges 200 and 300 and the area 120 of the glass pane surface 1-2.

For the most effective use of the glass panes installed in buildings, technical facilities, etc., the distances x₈ between the edge 100 of the respective largest glass pane 1 of the glass pane stack (see FIG. 2C) and the fixing area 601 are selected as small as possible (typically about 1 mm to 3 mm). In other installation variants, it can be advantageous if the distance x₈ is even slightly enlarged (e. g. to about 5 mm to 10 mm), so that the glass pane 1 clearly protrudes the profiled frame 6, because the mechanical stability of the glazing elements 10 can be increased further this way.

The distance x₇ between the spacers 500 arranged closest to the edge seal assembly 601-604 and the inner area of the sealing surface 6-1 provided closest to the spacers may be selected in such a way that the critical bending/pulling-related tensions in the edge area of glass pane 1 caused by the effect of the air pressure can be avoided or minimised on the one hand and the size of the provided evacuable volumes 4-3 and the cross-sectional areas Aᵥ is still adequate on the other hand. If using not prestressed or unhardened glasses with thicknesses of e.g. about 3 mm to 6 mm for glass pane 1, the distances x₇ should be set to values of smaller or equal to about 45 mm. For hardened and/or thicker glass panes 1, it is also possible to use larger distances (e. g. up to about 70 mm for glass with a thickness of 10 mm).

Glazing elements or parts thereof are illustrated in FIGS. 1, 3, 4, 5, 8 as cross-sectional representations, where the profiled frame is arranged underneath. The disclosure also includes mirror-inverted arrangements and constructions with profiled frames etc. attached from the top, because the advantages according to the disclosure for the glazing element 10 are not altered as a result.

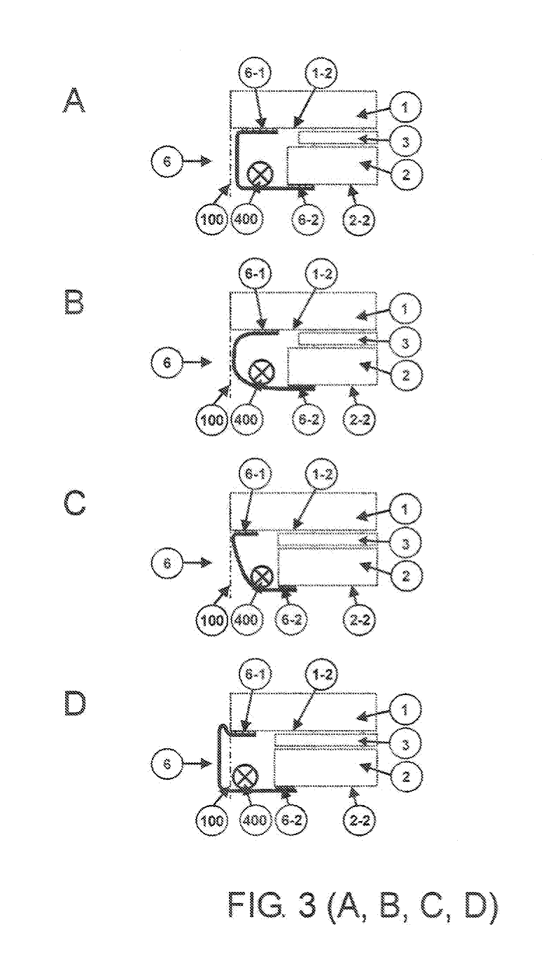

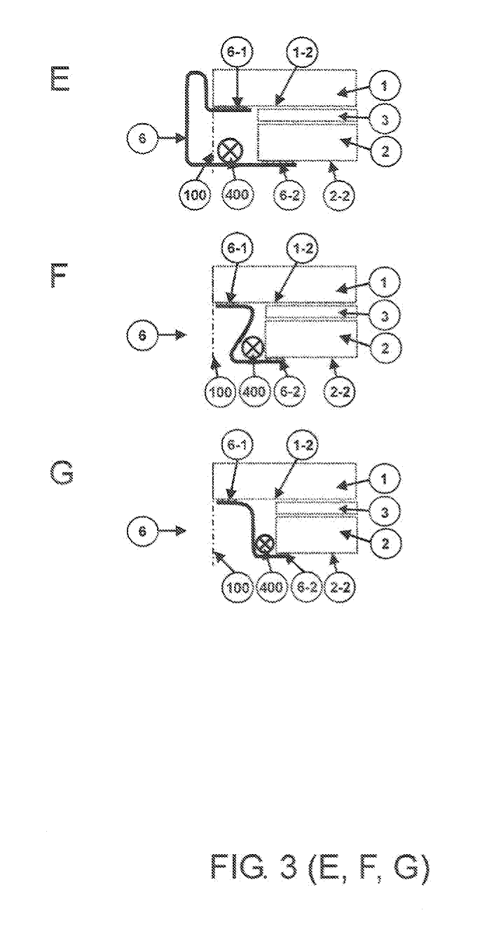

With respect to the design of the profiled area 603 with the arched areas 604 of the profiled frames 6, different geometries or combinations thereof can be used according to the invention. A plurality of preferred design variants are illustrated in FIG. 3, where the encircling frames 6 are connected vacuum-tight in the edge areas of the glass pane surfaces 1-2 and 2-2 with glass panes 1 and 2. As illustrated in FIGS. 2, 3A to 3G, the profiled area 603 of frame 6 can comprise for example a C-, U-, Z-, S-, Ω-profile, different geometries with multiple components, a step, an arch-shaped/like and/or geometrically similar shape or also combinations thereof. In addition, variants are possible where parts of the edge seal assembly 601-604 extend for example beyond the edge plane 100 of glass pane 1 (compare FIGS. 3D, 3E) and/or protrude the surface 2-2 of glass pane 2 and/or surface 1-1 of glass pane 1 (not shown here). If such embodiments are used, please take into account that the frame 6 could be damaged and as a result destroyed even due to simple mechanical stress (for example during the packaging, transport, the installation of the glazing elements 10 etc.) and is therefore preferably protected with an additional exterior protective device (enclosure 9).

The profiled frame 6 can be expanded or combined with other parts on the fixing areas 601, 602, for example for the purpose of providing additional seals and/or for coupling a plurality of glazing elements 10 or other components and/or to create connections with framing, holding and handling facilities etc.

Aside from the different geometries according to FIG. 3, the profiled area 603 of the profiled frames 6 can be outfitted with other constructive elements affecting the stability of the profile, such as for example with recesses, channels or grooves and similar. The mechanical properties can also be influenced within certain limits by providing frames 6 consisting of a metallic material with changeable thickness and/or changeable stability (for example by means of local heat treatment).

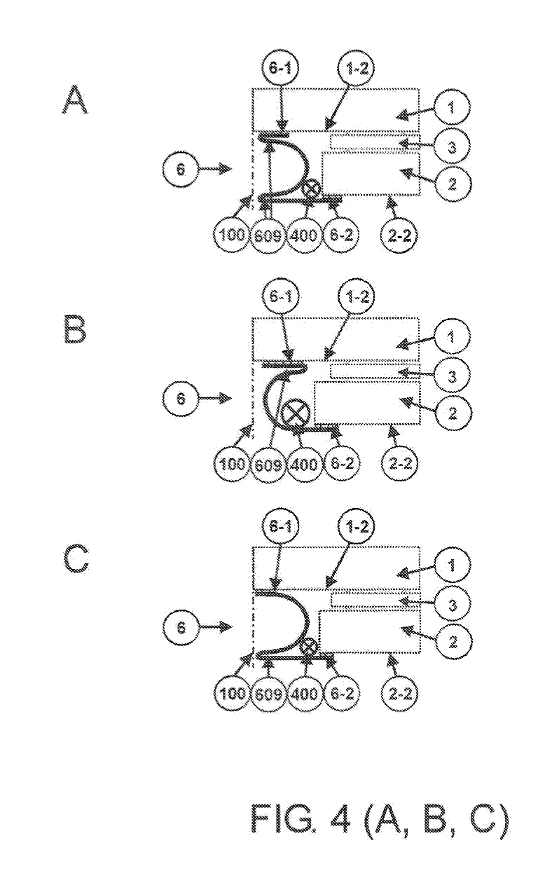

FIG. 4 shows exemplary embodiments with changing radii of bend, for which the profiled area 603 of frame 6 comprises a C-shaped basic geometry (large radius of bend) and areas 609 are provided with smaller radii of bend, making it possible to achieve specifically a local hardening of the profiled frame 6.

According to FIG. 5, variants for the profiled frame 6 comprise a profiled area 603, containing at least one first arched area 604 and al least a second arched area 605 (see FIGS. 5A to 5E), wherein at least one of the arched areas (605) is arranged close to the glass pane surface 1-2 and the bridge areas 606 between the arched areas 604, 605 are at least partially arranged almost parallel or at a slight incline to the edge planes 100, 200. The diameters of the curves of the arches are preferably set to values of at least about 1.0 mm or larger. The areas 606 between the arched areas are sized in such a way that the profiled frame fully occupies the space formed by the glass pane surface 1-2 and the edge plane 200 and an evacuated space 4-3 as large as possible is still available. The radius of bend for the transition areas 607 between the profiled area 603 and the fixing areas 601, 602 is preferably adjusted in such a way that no major deformations can occur in these positions.

FIGS. 5A and 5B illustrate shapes where the profiled area 603 comprises exactly one first arched area 604 and one second arched area 605. According to FIG. 5C, exactly two or according to FIG. 5D exactly three arched areas 604 and 605 are provided in particularly preferred embodiment variants. Indeed, by using four and more arched areas, the volumes in the evacuated spaces 4-3 can be enlarged further, but the costs of the profiles may rise because of the more expensive manufacture.

Surprisingly, it was determined that the usability of large-size glazing elements could even be increased with the specific arrangement of parts of the frame. It consists in that according to the invention at least one arched area 605 is arranged in such a way that the latter is at least partially in direct contact with the glass pane surface 1-2 in area 608 (sec FIGS. 5C, 5D). To reduce the associated frictional forces and as a result the damages of the contact areas between the arched area 605 and the glass pane surface 1-2, the surfaces of the adjacent materials can be provided with friction reducing coatings or similar.

By providing the arched areas 609 (see FIG. 5E), which may have different radii of bend compared to the main arches, it is on the one hand possible to further enlarge the volumes of the gaps 4-3 in a advantageous manner and on the other hand to further increase the overall stability of the frame within certain limits, so that the mechanical tensions, in particular at the sealing surfaces 6-1, 6-2 can also be reduced further.

The embodiment variants shown in FIG. 5 only serve as an example. According to the disclosure, the arched areas 604, 605, 607, 609 can be provided with freely selectable and/or differing radii of bend and/or form areas 606 with different lengths and/or with different angles of inclination, and/or use combinations with other geometries to obtain stable and usable glazing elements 10.

Known bending operations such as e.g. punching can be used for the provision of the profiled frame 6. However, these operations are very expensive and costly for profiled lengths of approximately 1,500 mm and longer. The profiled frames 6 are preferably manufactured by means of roll forming or contour roll forming operations, wire and bar drawing or combinations thereof. It has been demonstrated that the profiled frame 6 can be manufactured in excellent precision and almost any profiled lengths at a reasonable price with the preferred methods. When using metals or metal alloys for the profiled frame 6, thicknesses for the profiled frame 6 of preferably about 50 μm to about 300 μm are provided. The actual material thickness is to be selected by the user depending on the used profile design as well as the used materials. The thicknesses of all materials may be selected within a preferred thickness range.

The scaling surfaces 6-1, 6-2 between the profiled frame 6 and the glass panes 1, 2 preferably comprise solder glass, fritted glasses, a glass-like material or substances containing these materials, a metal or a metal alloy, a inorganic composite material, an organic composite material, a sol-gel compound, an adhesive and/or a permeation-resistant polymer or combinations thereof. It is essential that the materials used for the sealing surfaces 6-1, 6-2 are designed in such a way that superior and durable vacuum tightness, excellent adhesion to the glass panes 1, 2 and the profiled frame 6 as well as adequate thermomechanical stability of the glazing element 10 are guaranteed. In a particularly preferred variant, a glass solder or a material containing glass solder that softens at low temperatures (<540° C.) is used at least partially, which possesses the same or at least very similar thermal expansion coefficient as the glass panes 1, 2 and the profiled frame 6, and preferably melts at temperatures of lower or equal to about 540° C., and contains at least one of the oxides of the elements lead, lithium, bismuth, sodium, boron, phosphorus and/or silicon. If the difference of the thermal expansion coefficient between the directly adjacent material combinations of the frame and sealing area and sealing surface and glass pane is smaller or equal to about ±1·10⁻⁶ K⁻¹ according to a preferred variant of the invention, it results in advantages for a particularly low-tension connection.

To guarantee an adequate mechanical stability and vacuum tightness with the preferred use of the materials containing glass solder, a thickness ranging preferably between about 20 μm to about 800 μm, preferably between about 20 μm and about 600 μm is provided for the scaling surfaces 6-1, 6-2, while the width of the scaling surfaces 6-1, 6-2 is set to values ranging from about 1 mm to approximately 15 mm, preferably between about 1 mm and about 10 mm.

By using metal frames 6, their good electrical conductivity can be utilised at least partially also for the local heating of the sealing surfaces 6-1, 6-2. For this purpose electrodes are attached to the frame analogous to a resistance heater, thus generating a flow of current at least through parts of the frame.

An exemplary variant of the disclosure also comprises procedures for the improvement of the adhesion and as a result the load bearing capacity in particular for shearing forces at the contact points between the glass pane, sealing surfaces and frame, provided for example by applying additional adhesive or wetting coatings and/or by means of surface activation and/or by means of surface oxidation. In a particular embodiment, at least the faces of the fixing areas 601, 602 facing the sealing surfaces 6-1, 6-2 of the profiled frame 6 are at least partially provided with a defined surface roughness. This makes it possible to provide an even better adhesion of the glass solder-containing material on the metal surface.

The fixing surfaces 601, 602 can be provided with additional constructive elements such as for example openings, recesses, channels, grooves, rises, other surface modifications or similar to improve the adhesion and load bearing capacity at the contact point between the sealing surface and frame and/or for the defined setting of the thickness of the scaling areas.

If the sealing surfaces 6-1, 6-2 contain glass solder or similar substances, the profiled frame 6 comprises in a particularly preferred manner at least one component, consisting at least partially of at least one of the metal alloys, compounds or components such as e.g. iron-nickel (FeNi), iron-nickel-chromium (FeNiCr), iron-chromium (FeCr), and/or at least partially of at least one of the metals platinum, vanadium, titanium (both as basic component as well as alloy component) chromium (as alloy component), aluminium (as alloy component), cobalt (as alloy component). For example the following available alloys have proven to be particularly suitable: Fe—Ni alloys with a nickel ratio of close to 40% to close to 55% (e. g. FeNi48 or FeNi52), Fe—Ni—Cr alloys (e g. FeNi42Cr6, FeNi47Cr5-6, FeNi48Cr6 etc.), Fe—Cr alloys with a chromium ratio of about 23% to approximately 30% (e. g. FeCr28), special high-grade steels with a chromium ratio of approximately 15% to 20% (e. g. X6Cr17). Other alloy components can also be added.

For the provision of the sealing surfaces 6-1, 6-2 metal solders melting at low temperatures (below approx. 300° C.) can be used in other embodiment variants, which at least partially comprise one of the substances tin, indium and/or a tin-indium alloy and/or comprise at least one alloy component which comprises at least one of the elements Ag, Sb, Al, Bi, Cu, Au and Ni. Because the differences of the thermal expansion coefficients of the compound partners can be slightly larger here compared to scaling surfaces containing glass solder, it is also possible to use metals or metal alloys such as e.g. aluminium, other Fe—Ni steels etc.

To obtain an adhesion of the metal solder to the glass surfaces 1-2, 2-2 at all on the one hand and a good vacuum-tight and permanently stable seal on the other hand, it is necessary to apply a solderable and/or wetting-improving and/or reaction- and/or alloy-affecting and/or electrolytically active connection layer and/or a coating package comprising these functions and designed with a plurality of coatings to the glass surfaces 1-2, 2-2 of the fixing areas 601, 602 or at least to parts thereof. However, said coatings can also be applied to the corresponding surfaces of the metal frame 6.

Advantageously, the materials for a reactive connection layer as well as the methods for their provision described in DE 10 2007 030 031 B3 can be applied to sealing surfaces 6-1, 6-2 consisting of metal solder.

Another variant for the provision of at least one part of the sealing surfaces 6-1, 6-2 provides that a foil consisting e.g. of a metal (e.g. aluminium) or a frame 6 whose surfaces at least partially consist of such a material are connected to the glass surfaces 1-2, 2-2 without the application of additional scaling material. The adhesion between the metal foil and the frame is preferably achieved e.g. with ultrasonic welding or similar procedures.

The vacuum is provided and the glazing element 10 is scaled vacuum-tight by means of at least one evacuating device 71 provided on the side. It is proposed to provide a small opening, e.g. in the form of a drill hole or similar in the profiled area 603 of the metal frame 6 and to attach a round evacuated tube 710 by means of e.g. laser welding on this spot. However, this variant has proven less suitable because the installation can be complicated, susceptible to failure and associated with high rejection rates. Instead, these disadvantages can be remedied according to the disclosure in that the evacuating device 71 comprises at least one cuff area at the contact point of the evacuating device and frame, with an at least almost closely contoured geometry in reference to the frame 6 (see 711 in FIG. 1C), on which the vacuum-tight connection is provided at least partially. This produces an at least partially well malleable and as a result less failure prone construction, thus saving production costs. Alternatively, the cuff area can consist of a shape deviating from the profile of frame 6, which can however be connected vacuum-tight at the edge of the cuff area with the frame 6. A sealing assembly 8 is provided for the purpose of the vacuum-tight sealing of the evacuated lube and the coupling element 710 after the evacuation and after achieving a vacuum pressure of preferably at least smaller or about equal to 1·10⁻¹ Pa.

By referring to the embodiments of the glazing elements and methods for their manufacture according to the disclosure, in particular by referring to the evacuation, sealing and vacuum creation assemblies, in particular the used materials, components, design, installation, provision procedure, conduct of the vacuum generation etc. as described in patent DE 10 2007 030 031 B3 can be used for the evacuating device 71.

The evacuating device 71 (compare FIGS. 1C, 6A) comprises at least one evacuated tube and coupling element 710, set up for linking up to a vacuum generation assembly and/or for the vacuum-light connection with at least one additional evacuating facility or a facility to be evacuated (e.g. an additional glazing element, an evacuated frame and holding construction, a vacuum panel and facade element and other insulation element, etc.), and an at least a partially closely contoured cuff area 711, on which the vacuum-tight connection with the frame 6 is at least partially provided. The vacuum-tight connection with the glass panes 1, 2 is provided with the sealing surfaces 6-1, 6-2 in the areas 631, 632.

In contrast to conventional methods, the evacuating device 71 makes it possible to provide the opening required for the evacuation with a larger cross-sectional area (at least about 6 mm² to 20 mm² and even larger compared to only about 1 mm² to about 3 mm² with the known methods), so that the evacuation times, in particular in the pressure range of the molecular flow can be reduced by a multiple to sometimes several 10 seconds. This not only shortens the production times, but also helps save investment costs for the vacuum technology.

The evacuated tube and the coupling element 710 preferably comprise a circular, oval or elliptic cross-section, but almost any geometries deviating hereof can be used, for example with a square, rectangular, segmented, kinkable or malleable, wavy cross-section or a cross-section consisting of several segments or similar. In the simplest case, the evacuated tube and coupling element 710 illustrated as side view in FIG. 2C possesses a cylindrical shape where both sides are completely open. Other variants in terms of tube geometry and installation are also possible. The evacuated tube and coupling element 710 can be installed parallel to the glass pane edges (see FIG. 2C) or at any incline or facing downward. Other embodiment variants provide that the evacuated tube and coupling element 710 or parts thereof further project into the gaps 4-3, wherein a distance of preferably at least 1 mm and greater should be provided between the inward facing openings of the evacuated tubes 710 and the edges 200, 300, so that the evacuation times are not extended unnecessarily.

The evacuated tube and coupling element 710 is preferably provided with geometrically ductile parts, adapters, connecting and coupling pieces or similar on the outward facing side, to make the connection with a vacuum apparatus very easy.

The material and material thickness for the evacuated tube and coupling element 710 should be provided such that it is capable of withstanding a pressure of at least 1 bar and no pores, fractures and other microscopic damages with a negative impact on the gas impermeability can occur. With the use of the preferred metallic materials, a thickness of approximately 50 μm to 400 μm proved to be suitable, depending on the respective actual geometry.

For the evacuated tubes and coupling elements 710 it may be preferable to use such metals or metal alloys or substances containing the latter which are also used for the closely contoured cuff areas 711. It may be advantageous if the evacuating devices 71 are provided in one piece by means of e.g. multi-stage mechanical bending or multi-stage deep-drawing or similar of flat rolled starling material.

Identical materials or materials with similar mechanical properties may be used for the evacuated tubes and coupling elements 710 and the closely contoured cuff areas 711 and the profiled frame 6. We would like to point out explicitly that it is also possible to use different metals and metal alloys for the evacuated tubes and coupling elements 710, the closely contoured cuff areas 711 and the profiled frame 6. For example, it is possible to combine alloys containing iron-nickel (FeNi), iron-nickel-chromium (FeNiCr), iron-chromium (FeCr) etc. with NiCr-containing compounds, without resulting in limitations or impairments of the glazing elements 10. The only crucial factor in this context is that the used materials can be connected vacuum-tight on the one hand and do not show any material fatigue when used with the glazing element 10 on the other hand.

It may also be advantageous to provide materials whose thermal expansion coefficients do not differ too much from each other in order to minimise the thermomechanical tensions on the connecting points. The use of different materials can achieve a certain adjustment of the thermal expansion coefficients within certain limits by providing intermediate layers, using sandwiched metal fasteners or similar.

In reference to patent DE 10 2007 030 031 B3, the scaling assembly 8 preferably comprises in part a metallic sealing material which melts at low temperatures (<approx. 300° C.), preferably comprising the elements tin and/or indium, alloys thereof as well as compounds comprising these materials as an essential component, wherein other alloy substances which comprise at least one of the elements Ag, Sb, Al, Bi, Cu, Au, Ni etc. can be added. The vacuum tightness is provided after the completion of the evacuation process by means of known melting procedures (e.g. heat supply by means of a heating spiral, laser or similar) of the starting material previously built in into the evacuated tube or coupling element 710.

The fact that the frames and evacuating devices according to the disclosure are built with metals and metal alloys results in an additional variant of the sealing assembly 8. It consists in that the vacuum sealing can also be conducted at higher temperatures (above the glass transformation temperature of about 540° C.) because of the excellent thermal conductivity of the metals (contrary to edge seals e.g. containing glass-like materials). For the sealing assembly 8, at least in part a metallic sealing material (hard solder can be used) that melts at a temperature range above about 600° C., which may comprise the elements silver, copper and/or nickel as an essential component. The sealing can be carried out in such a way that after achieving the desired vacuum pressure in the glazing element 10, the evacuated tube and coupling element 710 is mechanically pressed or sealed-off and/or sealed vacuum-tight through local melting of the hard solder by means of supplying heat (e.g. with radiation, inductive heating or similar). Because, of the higher melting temperature of the sealing material, it is now even possible to provide the starting material required for the sealing assembly 8 and the connection layer possibly required for a permanent seal between the scaling assembly 8 and the evacuated lube or coupling element 710 (see patent DE 10 2007 030 031 B3) in advance at least in part as component of the evacuating device 71 (e. g. in the form of a coating or an application, a segment or similar).

For the permanent conservation of the vacuum, it may be advantageous if at least one getter material or an assembly containing getter material 400 (getter assembly) is arranged in at least one evacuated space 4-1, 4-2, 4-3 of the glass pane arrangement. According to an exemplary embodiment, the getter material or getter assembly may be preferably at least for the most part built in into the evacuated area 4-3, because the available volume in this area is particularly large, thus allowing the smooth integration and suitable activation of a sufficient amount of getter material. Substances containing at least one of the elements barium, magnesium, especially elements with a higher melting point such as thorium, zirconium, aluminium, titanium etc. or combinations thereof may be used for the gettering. The activation can be achieved via local thermal evaporation, wherein the required energy is provided e.g. by electrical, laser, microwave, plasma or induction facilities. Because of the fact that the edge seal assembly 601-604 and the evacuating facility 71 according to the disclosure are built of metallic materials, the getter assembly can be directly connected or in direct contact with them, so that the thermal energy required for the activation is achieved with the local healing of the corresponding part of the edge seal or the evacuating device. When coupling the thermal energy via glass panes 1, 2, e.g. by means of laser radiation or similar, the good thermal conductivity of the metal forming the edge seal or the evacuating device can be used specifically for local cooling, in order to not damage the other components and parts of the glazing element 10.

In an advantageous variant the geometry and the arrangement of the edge seal assembly 601-604 and possibly also the evacuating device 71 are selected in such a way that they are not protruding the plane 100 of the glass pane 1 even when in use (see FIG. 2C). This allows the installation of the glazing element 10 for example at least partially on the glass edge 100 in a perpendicular or inclined position, without the possibility of damaging the edge seal and evacuating device.

According to FIG. 1C, the glazing element 10 can be provided at the edge at least partially with an enclosure 9 or similar. The enclosure 9 can comprise e.g. a C-shaped or also an L-shaped cross-section as illustrated. This helps prevent mechanical damages of the glass edges as well as the edge seal assembly and evacuating device during the transport, installation etc. as well as unwanted corrosive environmental exposure. Different constructions comprising for example metals, synthetic materials and polymers, composite fibre materials, wood etc. as well as material combinations thereof can be used for the enclosure 9. The enclosure 9 is coupled to at least one glass pane 1, 2 in one of the areas 9-1, 9-2 and/or 9-3 at least partially by means of adhesions, in the form of clamping and pressing devices or combinations thereof or similar. Depending on the actual intended use of the glazing element 10, the areas 9-1, 9-2, 9-3 can be designed differently both in terms of used materials as well as the geometry. The enclosure 9 can at least partially be set up as part of the attachment and installation device for the glazing element 10 and/or provided with additional thermoinsulating diffusion-inhibiting and/or vacuum-tight functions.

The areas 9-1, 9-2, 9-3 preferably comprise at least one sticking, adhesive, sealing, blocking substance and/or one filling component, selected preferably from the group of materials comprising acrylates, cyanoacrylates, resins, epoxy systems, polyurethanes, polypropylene, polycarbonate, polyethylene, polyvinyl alcohol, polystyrols, acetates, polysulfides, silicone systems, copolymers, flexible rubber substances and similar. Moreover, diffusion-inhibiting compound systems or material combinations, in part containing thin metal foils, foils containing thin metal and/or oxide layers can be used.

To obtain a better protection of the edge seal assembly 601-604 against corrosive exposures, the spaces 9-4 between the enclosure 9 and the edge seal 6 or the evacuating device 71 can be provided with water vapour-inhibiting and/or water vapour absorbing components such as for example drying agents or similar. By integrating thermoinsulating materials such as for example mineral wool, polystyrol or similar into the spaces 9-4, the heat losses at the edges of the glazing element 10 can be minimised further. Under certain conditions, it is also possible to provide pressures in the spaces 9-4 that are lower compared to the exterior air pressure, so that the thermal insulation in the edge area can be improved even further.

The glazing element 10 and the method for its manufacture according to the disclosure are capable of overcoming the disadvantages of conventional glazing elements mentioned above in terms of sensitivity of the corner areas. An exemplary embodiment variant comprises a completely self-contained filigree and miniaturised edge seal assembly 600 (see FIG. 6A), containing at least one corner connector 62 with the areas 621, 622, 623, which are joined vacuum-tight in the areas 624 with the fixing areas 601, 602 and the profiled area 603 of the edge parts of the frame 6. Every corner can be provided with a corner connector 62. The glass panes 1 and 2 are connected with the areas 601, 621 and 602, 622 via sealing surfaces 6-1 and 6-2, to provide the vacuum-tight enclosure for the glazing elements 10 in this way.

Surprisingly, said filigree edge seal assembly 600 can even be used for the provision of glazing elements with large dimensions of 2,000 mm×2,500 mm and larger. These advantages are due lo the fact that the glass panes 1, 2, 3 are arranged in such a way with the edge seal assembly 600 according to the disclosure, that the stack of glass panes and the edge seal assembly are self-adjusting and -stabilising with the provision of the sealing surfaces 6-1, 6-2 (see high process temperatures of up to about 500° C. amongst other things). This way, expensive, complicated and as a result costly holding and press facilities are for the most part not required for the manufacture of the glazing elements.

The corners of the corner connectors 62 are not sharp-edged, but can be provided with a certain roundness. The dimension of these roundings or curvatures can vary depending e.g. on the shape and size, the actual installation and utilisation conditions of the glazing element etc. This rounded design makes is possible to provide the coupling of the mechanical forces on the glass surfaces 1-2, 2-2 not exactly on the corners, but slightly away from the corners of the glass panes 1, 2, so that breakages of glass, fractures or similar, which develop on the corners or their immediate vicinity e.g. because of microscopic damages caused when the glass panes are cut, are preventable as much as possible.

It is not necessary that the side profile geometry of area 623 of the corner connectors 62 is identical or similar across the entire surface between the contact areas 624 as the area 603 (compare FIGS. 2, 3, 4). However, it is essential in certain embodiments that the side profile geometries of the frames 6 and the corner connectors 62 are at least almost identical, but at least very similar at the contact points between the frame and corner connector 624. This allows putting together the components with a precision fit and tension-free when manufacturing the glazing elements. The permanently vacuum-tight connection can be provided with a perpendicular or slanted arrangement of the connection partners and created by means of known procedures, such as e.g. arc welding etc. A variant provides that the connection is created by means of laser welding. In the process, the connecting partners corner connector 62 and frame 6 are put into an abutting position or a slightly overlapping position on the contact point 624 and then welded together vacuum-tight.

Another exemplary embodiment variant provides that the connection is created by means of a special solder procedure using hard solders at typical work temperatures ranging between about 600° C. and about 1000° C., such as between about 650° C. and 900° C. The special soldering procedure is set up for example in such a way that the corner connector 62 is first placed into a special tool with a precise fit. The edge parts of the frames 6 bordering the corner connector are placed laterally into the tool in such a way that a contact area 624 is created where the connecting partners overlap, wherein the width of the overlapping area 624 can be selected in a range of at least about 1 mm to about 10 mm. The solder material can comprise a substance which at least partially contains the elements silver, copper and/or nickel as a component. After the solder material has been brought into the contact area 624 or at least in its immediate vicinity for example in the form of a paste, a wire, a foil or similar (also flux, if necessary), the area 624 is heated by means of e.g. inductive heating so that the solder material is melting. The special tool provides the required local contact pressure and distancing, providing a vacuum-tight and mechanically well loadable connection after the cooling. The solder thickness is preferably set to values between about 10 μm and about 250 μm.

We would like to point out that the materials, facilities and methods preferred for the provision of the contact areas 624 can also be used for the provision e.g. of the contact areas 625 between the at least one evacuating device 71 and the frame 6 and are considered an integral component of the invention.

Particularly stable connections can be achieved if the closely contoured geometry for the edge and corner connectors of the profiled frame is set up in such a way that the profiled side is not switched from the outside to the inside and vice versa along the entire contact area 624 between the sealing surfaces 6-1, 6-2 (see e. g. FIGS. 1A to 1C, 3F, 3G, 4B, 4C, 5B to 5E). This advantage is due to the fact that the mechanical tensions on the sealing surfaces 6-1, 6-2 can be reduced further with this particularly preferable design variant. The levels and height differences occurring along the glass pane edges in the sealing surfaces 6-1, 6-2 of the overlapping connections 624 (see profile thickness plus thickness of the solder layer) can be equalised by adjusting the thickness of the sealing surfaces.

Other variants for the edge parts of the profiled frame 6, the evacuating device 71 and the corner connectors 62 of the profiled frame 6 at least partially comprise the provision of the surfaces with permeation-resistant coatings and/or surface modifications (e.g. through oxidation), so that the diffusion of glass molecules into the inside of the glazing element 10 can be reduced further, thus achieving the longer lifespan of the components.

The top view in FIG. 6 shows exemplary edge sealing assemblies 600, in which the mutual distances of the areas 621, 622, 623 also remain constant to each other in the roundings, bends and curvatures (compare distances x₁ to x₄ in FIG. 2A). In the symmetrical embodiment illustrated there, the roundings and curvatures are designed as segments of a circle with a mutual centre of the circle. However, geometries deviating from the circles, different reference points, different expansions x₁, x₂ can also be used for the areas 601 to 603 and 621 to 623 etc. Furthermore, corner connectors 62 are possible in which the areas 621, 622 are provided with different degrees of bends, curvatures or similar.

In addition, we would like to point out explicitly that the corner connectors 62 can be provided with identical or at least similar materials and components, identical or at least similar structural and process control-related procedures (see. e.g. channels, grooves, coatings, etc.), as those described in the textual copy and the Figures for the edge parts, the evacuated tube and coupling element 710 and the closely contoured components 711.

It has been shown to be particularly advantageous that an opening across the entire circumference between the glass edges 200, 300 and the frame is created as a result of the arrangement of the edge seal assembly, corner connectors and framing assembly. Compared to the known vacuum insulated glazing, the encircling opening is provided with a much larger cross-sectional area (at least about 6 mm² to 20 mm² and more), so that the gas molecules located further away from the evacuating device are no longer required to cover the entire pathway by moving through a very narrow opening between the glass panes to be pumped off. The disclosure makes it possible to create a suitable pressure difference between the encircling opening 4-3 and the spaces 4-1, 4-2, so that the molecules can now move into the closest part of the opening on all sides of the glazing element and are fed into the evacuating device via this opening.

The following simplified process sequence applies lo an exemplary manufacture of the edge seal assembly 600 according to the disclosure:
Provision of the starling material for the frame with the edge parts and the corner connectors 62,
Provision of the evacuating device 71,
Cutting of the starting material for the frame to the desired dimensions of the respective glazing elements 10,
Provision of at least one recess or opening in at least one frame 6 to accommodate the evacuating device 71,
Pooling of the individual components 6, 71, 62 and provision of the vacuum-tight connections 624, 625.

The structural components required for the provision of the edge seal assembly 600 are illustrated schematically in FIG. 6B. In the exemplary illustrated example, the evacuating device 71 is attached separately to one of the edge parts of the frame 6 and as a result slightly distanced from the corner area, making it possible to reduce the mechanical tensions further. For this purpose, the profiled frame 6 is divided into components 6a and 6b and the evacuating device 71 is subsequently connected with the components 6a and 6b via contact points 625 (see FIG. 6A). To achieve a simple coupling with the vacuum system, the evacuated tube and cuff area 711 can slightly protrude the edge of the frame 6. After the evacuation and the vacuum-tight sealing, the evacuated tube and cuff area can be shortened to the desired length.

The edge seal assembly 600 also comprises variants in which the evacuating device 71 is a direct component of the corner connectors 62 and/or is directly connected at the contact points 624 with the corner connectors 62. The number and shape of the respective individual components 6, 71, 62 and the geometry of the edge seal assembly 6000 can deviate from FIG. 6B and shall be defined by the user depending on the respective actual designs.

The method for the manufacture of the glazing elements 10 described below with the inclusion of the assemblies for the edge seal (6, 6-1, 6-2), the evacuation (71) and the corner connection (62) according to the disclosure is an exemplary embodiment variant of the disclosure. Other combinations and modifications with other methods are also possible.

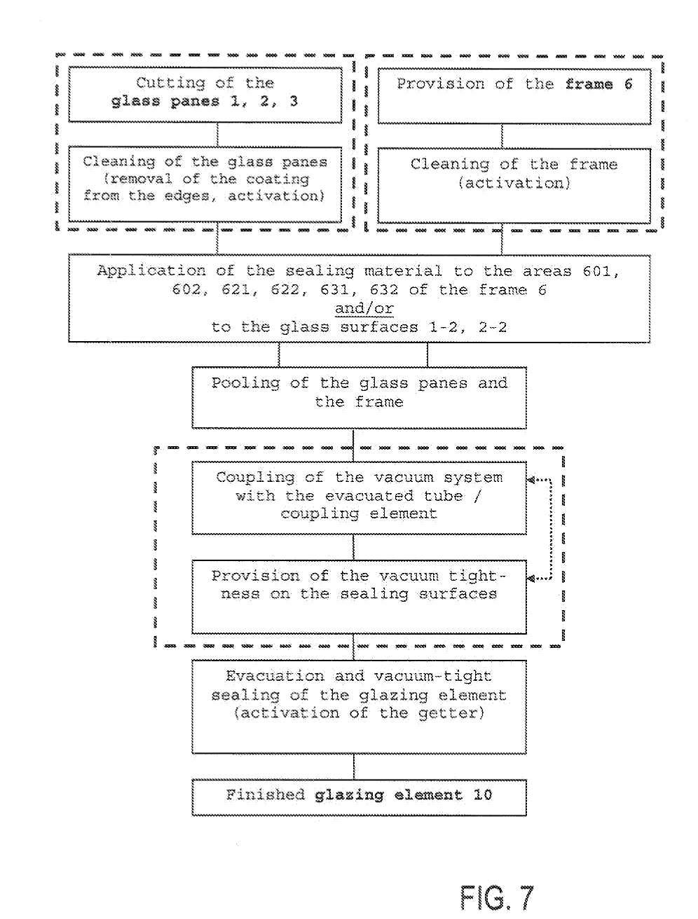

In a first procedure step according to FIG. 7, the method comprises the provision of the glass panes 1, 2, 3 (e. g. cutting, cleaning, removal of coating from the edges, activation of the glass surfaces at least in the sealing surfaces 6-1, 6-2 if necessary) and the provision of the edge seal assembly 600 (e. g. cleaning, activation of the glass pane surfaces). In preferred variants, the spacers 5 are firmly connected with the glass surfaces 1-2, 3-1, 3-2 and/or 2-1, and/or can be applied to the glass surfaces during the pooling or stacking of the glass panes.

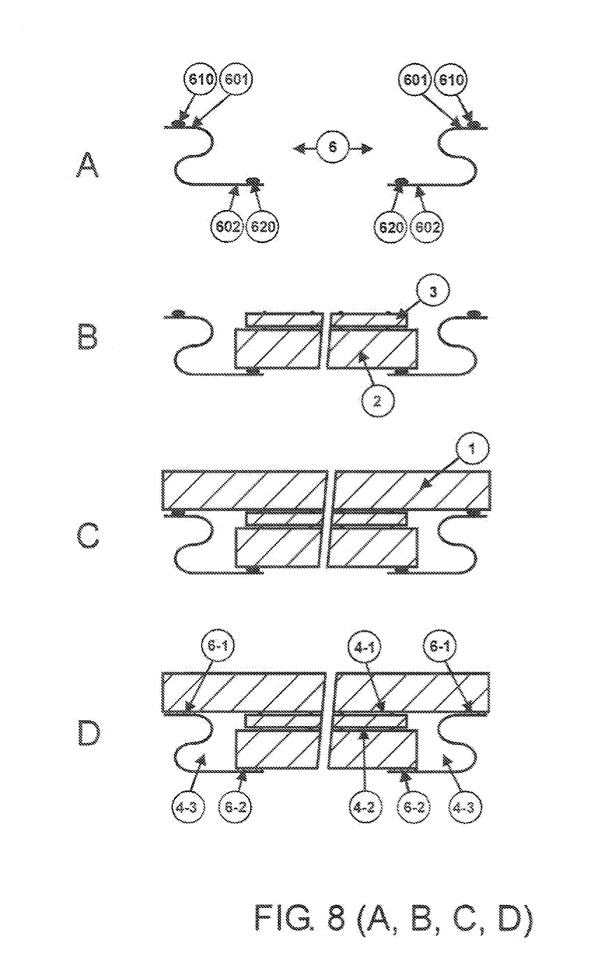

In a second step (see FIG. 8A), the sealing material 610, 620 is applied to the outer areas 601, 602, 621, 622, 631, 632 of the edge seal assembly 600 running parallel to the surfaces of the glass panes 1, 2, 3 and/or to the corresponding parts of the glass surface areas 1-2, 2-2. It is essential that the accurately positioned and precise application of the sealing materials by using e.g. dosing systems is done around the entire circumference and without any interruptions, openings or similar. The sealing materials 610, 620 can comprise substances containing glass-like materials and/or glasses that soften at low temperatures (for example solder glasses, fritted glasses or similar), which can be provided in the form of adhesive and/or solvent-containing pastes, suspensions, foils, fasteners or similar.

Then the glass panes are consecutively placed onto the sealing material 610, 620 to obtain the slack illustrated in FIG. 8C. In principle, the stack can also be provided in reverse order, by first placing the glass panes on top of each other, followed by the placement of the framing assembly.

The fourth process step comprises the provision of the mechanical connection between the evacuated tube/coupling element 710 and the vacuum system and the pooling of the stack and as a result the provision of the vacuum tightness in the sealing surfaces 6-1, 6-2.

The pooling can be achieved by melting the sealing material by means of heat treatment. In an exemplary manner, the particularly even contact pressure across the entire size of the components required to obtain a reliable sealing surface is provided at least for the most part by the own weight of the glass panes 1, 2, 3. Then a glazing element 10 (see FIG. 8D) is provided which does not feature any heat-insulating properties because the vacuum is still missing.

According to a fifth process step, the required vacuum conditions within the glazing element 10 are provided through evacuation by means of a vacuum system under exterior air pressure conditions. The evacuation can already be started during the pooling process, namely exactly at the time when the molten sealing material has not yet completely hardened or solidified and is malleable with the application of some force. This additional contact pressure provided with partial vacuum is particularly advantageous because particularly uniform pressure forces are provided as a result of the air pressure acting from the outside, allowing the even better equalisation of the production-related tolerances, dimensional accuracy etc. of the molten sealing material.

After achieving the vacuum pressure of at least 10⁻¹ to 10⁻³ Pa and lower, the evacuated tube 710 is sealed vacuum-tight using the described methods. By activating the getter 400, the vacuum conditions can be improved further.

The pooling, evacuation and vacuum-tight sealing can also be carried out under vacuum conditions.

The provision of a permanent vacuum concludes the manufacture of the heat insulating glazing element 10, with which particularly favourable thermal insulating values (U-values) of about 0.5 to about 0.3 W/(m²K) and even lower can be achieved.

The illustrated exemplary embodiments cannot only be used in the illustrated form; in fact, any combinations of these examples are possible.

The component not only comprises the use of glass or similar as material for the panes, which represents a special case for transparent and semi-transparent components. In principle, any materials can be used that can be manufactured with larger, plate-shaped or bent and curved geometries, possess adequate mechanical stability and are vacuum-capable.

The features of the disclosure contained in the description, drawings and claims above can be significant for the realisation of the disclosure and in its various designs alone, modifications or also in combination.

1.-16. (canceled)

17. A heat insulating glazing element, comprising:
a glass pane arrangement with a first outer glass pane and a second outer glass pane, of which the first outer glass pane protrudes the second outer glass pane along the entire circumference by an overlapping surface,
a spacer assembly comprising spacers provided for setting a distance between the glass panes, and
an edge seal assembly for sealing a gap between the glass panes against the surroundings and comprising a profiled frame attached vacuum-tight to the overlapping surface of the inside of the first outer glass pane, wherein
the glazing element is set up in such a way that the pressure in the gap is lower compared to the exterior atmospheric pressure,
the frame is attached vacuum-tight to an outer face of the second outer glass pane and forms an evacuated space connected to the gap at the side edge of the second outer glass pane, and
at least one evacuating device is provided which is arranged through the frame for the evacuation of the evacuated space.

18. An element according to claim 17, in which the frame comprises fixing areas on which the frame is connected with the glass panes and a profiled surface comprising several arched areas arranged along the side edges of the glass panes and which are arched in one direction parallel or perpendicular to the overlapping surface.

19. An element according to claim 18, in which the profiled area of the frame between the arched areas is arranged almost perpendicular or almost parallel to the overlapping surface.

20. An element according to claim 18, in which the arched areas directed at the first outer glass pane at least partially touch the inside of the latter.

21. An element according to claim 17, in which the glass panes are provided with a first sealing surface and a second sealing surface which are level and parallel to one another and on which the fixing areas of the frame are connected analogously with the first and the second outer glass pane.

22. An element according to claim 21, in which the first sealing surface and the second sealing surface contain a solder glass which:
softens at a temperature of below 600° C., in particular below 540° C.,
comprises a thermal expansion coefficient matched to the thermal expansion coefficient of the glass panes and the frame, and
contains at least one of the oxides of the elements lead, lithium, bismuth, sodium, boron, phosphorus and silicon.

23. An element according to claim 21, in which the exterior atmospheric pressure acts on the first and second fixing areas.

24. An element according to claim 21, in which a perpendicular distance from an inner edge of the first sealing surface facing the evacuated space to the next spacer assembly is smaller or equal to 5.0 mm.

25. An element according to claim 17, in which the frame comprises at least one of the features:
the frame comprises at least a C-, U-, ΩS-profile,
the frame comprises stabilising elements such as for example recesses, channels or grooves,
the frame comprises variations in the thickness,
the frame comprises variations in the strength,
the frame comprises a thickness of less than 500 μm, in particular less than 300 μm, and greater than 50 μm, in particular greater than 70 μm,
the frame comprises at least one of iron-nickel (FeNi), iron-nickel-chromium (FeNiCr), iron-chromium (FeCr), platinum, vanadium, titanium, chromium, aluminium and cobalt, in particular a Fe—Ni alloy with a nickel ratio of 40% to close to 55%, a Fe—Ni—Cr alloy, a Fe—Cr alloy with a chromium ratio of 23% to 30% or a high-grade steel with a chromium ratio of 15% to 20%, and
the frame comprises at least three arched areas.

26. An element according to claim 17, in which the frame comprises edge parts extending alongside the edges of the glass panes and corner connectors used to connect two adjacent edge parts each in the corner areas of the glass panes, wherein the corner connectors each comprise a rounded, in particular several fold curved material web.

27. An element according to claim 17, in which the evacuating device comprises at least one evacuated line set up for attaching a vacuum assembly and a cuff area at least partially fitted to the profile of the frame which is connected vacuum-tight with the frame.

28. An element according to claim 17, in which at least one inner glass pane is arranged between the first and the second glass pane, whose surface area is smaller than the surface area of the first outer glass pane, wherein the gap between the glass panes leads into the evacuated space.

29. An element according to claim 28, in which the at least one inner glass pane directly borders on the edge seal assembly.

30. An element according to claim 17, in which the evacuated space comprises at least one of a sensor assembly, a measuring assembly and a getter assembly.

31. A component comprising at least one glazing element according to claim 17.

32. A method for the manufacture of a glazing element comprising the steps of:
supplying glass panes in a glass pane stack with spacers of a spacer assembly, material of a frame of an edge seal assembly and an evacuating device,
cutting of the material of the frame of the edge seal assembly to match a desired dimension of edge and corner connectors,
providing at least one opening in the material of the frame of the edge seal assembly and mounting of the evacuating device in the opening,
pooling of the glass pane stack, the frame of the edge seal assembly and the evacuating device and providing vacuum-tight connections of the edge parts, the corner connectors and the evacuating device to form a circumferential frame and the vacuum-tight connections of the frame with the outer faces of the outer glass panes of the glass pane stack.
